(19) United States
(12) Patent Application Publication
(10) Pub. No.: US 2026/0151279 A1
(43) Pub. Date: Jun. 4, 2026

(54) FOLDING MOBILITY SCOOTER

(71) Applicant: ZHEJIANG HFIZER MEDICAL EQUIPMENT CO.,LTD., JINHUA (CN)

(72) Inventor: XIAONENG HU, YONGKANG (CN)

(21) Appl. No.: 18/967,839

(22) Filed: Dec. 4, 2024

(51) Int. Cl. A61G 5/08; A61G 5/10

(52) U.S. Cl. CPC A61G 5/0833; A61G 5/0875; A61G 5/0883; A61G 5/1051; A61G 5/1072; A61G 2200/34

(57) ABSTRACT

Disclosed is a folding mobility scooter, including a frame assembly. The frame assembly includes a first frame and a second frame. The first frame includes first cross bars and connecting seats. The connecting seats are integrally in bent plate shapes and provided with notches. The second frame includes second cross bars. The second cross bars are provided with avoidance through holes. A movable member is movably connected in the avoidance through holes. A sliding rod is connected to the movable member. A fixed plate is fixed on the second cross bars and provided with a via hole for sliding connection with the sliding rod. Elastic members are arranged between the movable member and the fixed plate. After relative unfolding, the second cross bars are embedded in openings of the connecting seats and abutted against interiors thereof. The elastic members drive the movable member to be clamped into the notches.

### TECHNICAL FIELD

The present disclosure relates to the field of mobility scooters, and in particular to a folding mobility scooter.

### BACKGROUND

Mobility scooters are designed to help those suffering from obesity, disability and mobility problems to more easily engage in outdoor activities (such as camping). Sometimes, it is necessary to fold the mobility scooters up for convenient transportation.

However, folding structures of the mobility scooters on the market are more complicated and thus difficult to operate. Moreover, there are also problems with the overall structural stability of the mobility scooters due to their folding design. How to further simplify a folding process of the mobility scooter and make the structure of the folding mobility scooter more stable is the direction for designers to further improve mobility scooters.

### SUMMARY

To solve the above problems, the present disclosure provides a folding mobility scooter, which solves the problem of inconvenient and unstable folding of the mobility scooter.

The technical solutions adopted by the present disclosure are as follows: a folding mobility scooter includes a handlebar assembly, a frame assembly, a support assembly, a seat, and wheels, where the wheels are rotatably connected to the frame assembly, the support assembly is arranged on the frame assembly, the seat is detachably connected to the support assembly, the handlebar assembly is rotatably connected to the frame assembly, and an angle limiting device is arranged between the handlebar assembly and the frame assembly; the frame assembly includes a first frame and a second frame, the first frame includes first cross bars and connecting seats, the connecting seats are fixedly connected to the first cross bars, the connecting seats are integrally in bent plate shapes, and the connecting seats are provided with notches along edges; the second frame includes second cross bars, and the second cross bars are provided with avoidance through holes in a penetrating manner; a movable member is movably connected in the avoidance through holes, and a sliding rod is connected to the movable member; a fixed plate is fixedly connected to the second cross bars, the fixed plate are provided with a via hole for sliding connection with the sliding rod, and elastic members are abutted against a position between the movable member and the fixed plate; and after the first cross bars and the second cross bars are relatively unfolded, the second cross bars are embedded in openings of the connecting seats and abutted against interiors of the connecting seats, and the elastic members drive the movable member to be clamped into the notches.

Through the above technical solution, a user can restore a rotational connection state between the first frame and the second frame by pulling the movable member to enable same to detach from the notches, making it very convenient to use; the second cross bars are abutted against the interiors of the connecting seats when the elastic members drive the movable member to be clamped into the notches; and the connecting seat are abutted against the second cross bars to limit limiting angles of the first cross bars and the second cross bars, and to bear the bending force between the first cross bars and the second cross bars, thus making force bearing points more numerous and the structure more stable.

Further, two second cross bars are provided, the two second cross bars are fixedly connected to two sides of the fixed plate, and the one movable member is simultaneously connected into the avoidance through holes on the two second cross bars.

Through the above technical solution, the force on both sides of the movable member is made more uniform, thus reducing the shaking caused by the movable member during use and making the service condition more stable.

Further, the movable member is set in a strip shape, a cross-sectional shape of the movable member is rectangular, a top surface of the movable member fits with upper part side edges of the avoidance through holes, and a lower surface of the movable member fits with lower part side edges of the avoidance through holes.

Through the above technical solution, the upper and lower surfaces of the movable member are allowed to fit with the upper and lower side edges of the avoidance through holes, making a sliding process of the movable member more stable and easy to control.

Further, the sliding rod includes bolts and nuts, the bolts are connected to the movable member, end portions of the bolts pass through the via hole and are connected to the nuts, and the elastic members are springs sleeved outside the bolts.

Through the above technical solution, the bolts, the nuts, and the elastic members are all common parts on the market and thus do not need to be produced. The bolts are connected to the movable member, pass through the springs and the via hole, and then are in screwed connection with the nuts, so that the installation of the sliding rod is completed. The installation steps are fewer, and the installation difficulty is low.

Further, two first cross bars are provided, the two first cross bars are both fixedly connected to a rotating seat, each of the two second cross bars is provided with a rotating block, the rotating seat is located between the two rotating blocks, and a rotating shaft passes through both the rotating blocks and the rotating seat.

Through the above technical solution, the one rotating seat is fixedly connected to the two first cross bars, so that the overall structure of the first frame is more stable.

Further, the handlebar assembly and the first frame are rotatably connected to each other; the angle limiting device includes a movable seat, a handle, and limiting plates; the limiting plates are fixedly connected to the first frame, each of the limiting plates is provided with a first limiting slot and a second limiting slot, the handlebar assembly is fixedly connected to the movable seat, the handle is rotatably connected to the movable seat, and the handle includes an operating rod and a limiting rod; when the limiting rod is clamped with the first limiting slots, the handlebar assembly is in an unfolded and locked state relative to the first frame; and when the limiting rod is clamped with the second limiting slots, the handlebar assembly is in a folded and locked state relative to the first frame.

Through the above technical solution, a user can control the handle and allow the limiting rod to be clamped into the first limiting slots or the second limiting slots to realize that the handlebar assembly and the first frame are locked in a relatively unfolded or folded state, so that the operation is very convenient.

Further, two limiting plates are provided, the movable seat is located between the two limiting plates, and two ends of the limiting rod protrude from both sides of the handle.

Through the above technical solution, the two ends of the limiting rod cooperate with the first limiting slots and the second limiting slots on the two limiting plates, making the structure more stable when the angle limiting device is locked.

Further, the first limiting slots and the second limiting slots are both extending in a strip shape, and angles formed between extension directions of the first limiting slots and extension directions of the second limiting slots range from 80 degrees to 100 degrees.

Through the above technical solution, the first limiting slots and the second limiting slots are both extending in a strip shape, so that the connection between the first limiting slots or the second limiting slots and the limiting rod is tighter, and detachment due to vibration is avoided during use. The angles formed between the extension directions of the first limiting slots and the extension directions of the second limiting slots are set reasonably, which ensures the effect of reducing the occupied space volume after folding.

### BRIEF DESCRIPTION OF FIGURES

In order to more clearly illustrate embodiments of the present disclosure or the technical solutions in the prior art, a brief introduction will be given below to the accompanying drawings required in the descriptions of the embodiments or prior art. It is evident that the accompanying drawings in the following descriptions are only some embodiments of the present disclosure. For those of ordinary skill in the art, other accompanying drawings can also be obtained based on the structures shown in these drawings without creative efforts.

FIG. 1 is a schematic diagram of the structure in an overall folded state;

FIG. 2 is a schematic diagram I of the structure in an overall unfolded state;

FIG. 3 is an enlarged partial view at Part A in FIG. 2;

FIG. 4 is an exploded view of the partial structure of the present disclosure;

FIG. 5 is a schematic diagram II of the structure in the overall unfolded state;

FIG. 6 is an enlarged partial view at Part B in FIG. 5;

FIG. 7 is a schematic diagram of the partial structure in the overall unfolded state; and

FIG. 8 is a schematic diagram of a connecting seat.

Description of reference numerals in the present disclosure:

1 denotes a handlebar assembly; 2 denotes a frame assembly; 3 denotes a support assembly; 4 denotes a seat; 5 denotes wheels; 6 denotes a movable member; 7 denotes elastic members; 8 denotes bolts; 9 denotes nuts; 10 denotes a rotating shaft; 11 denotes a movable seat; 12 denotes a handle; 13 denotes limiting plates; 21 denotes a first frame; 211 denotes first cross bars; 212 denotes connecting seats; 213 denotes notches; 214 denotes a rotating seat; 22 denotes a second frame; 221 denotes second cross bars; 222 denotes avoidance through holes; 223 denotes a fixed plate; 224 denotes a via hole; 225 denotes rotating blocks; 121 denotes an operating rod; 122 denotes a limiting rod; 131 denotes first limiting slots; and 132 denotes second limiting slots.

The implementation, functional characteristics, and advantages of the present disclosure will be further described in conjunction with the embodiments, with reference to the accompanying drawings.

### DETAILED DESCRIPTION

The technical solutions in embodiments of the present disclosure will be described clearly and completely hereinafter with reference to the accompanying drawings in the embodiments of the present disclosure. Apparently, the described embodiments are only a part rather than all of the embodiments of the present disclosure. All other embodiments obtained by a person of ordinary skill in the art based on the embodiments of the present disclosure without creative efforts shall fall within the protection scope of the present disclosure.

It should be noted that all directional indications (such as upper, lower, left, right, front, rear . . . ) in the embodiments of the present disclosure are only used to explain a relative position relationship and a motion situation between components in a specific posture (as shown in the figure). If the specific posture changes, the directional indication also changes accordingly.

Moreover, the descriptions related to “first”, “second”, and the like in the present disclosure are only used for descriptive purposes, and cannot be understood as indicating or implying their relative importance or implying the number of indicated technical features. Thus, the features defined with “first” and “second” may explicitly or implicitly include at least one of the features. In addition, the technical solutions of various embodiments can be combined with each other, which must be based on what those of ordinary skill in the art can achieve. When the combination of the technical solutions is contradictory or impossible to achieve, it should be considered that the combination of such technical solutions does not exist and is not within the scope of protection of the present disclosure.

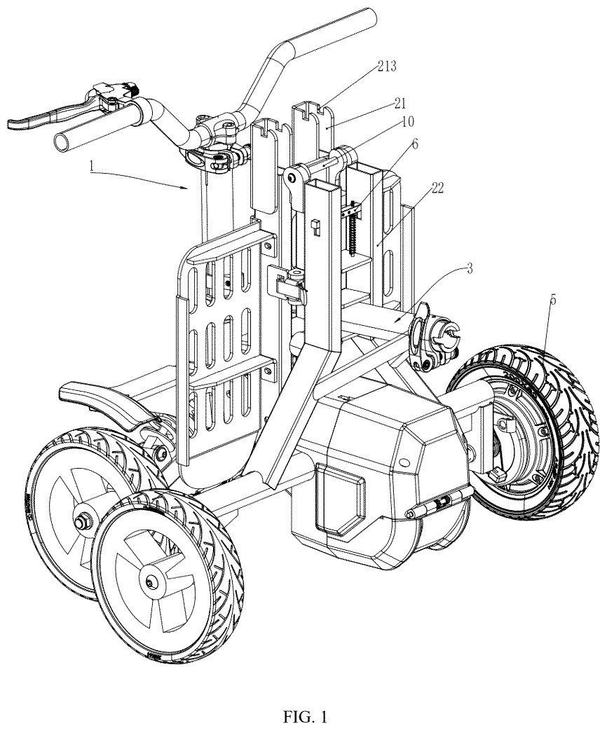

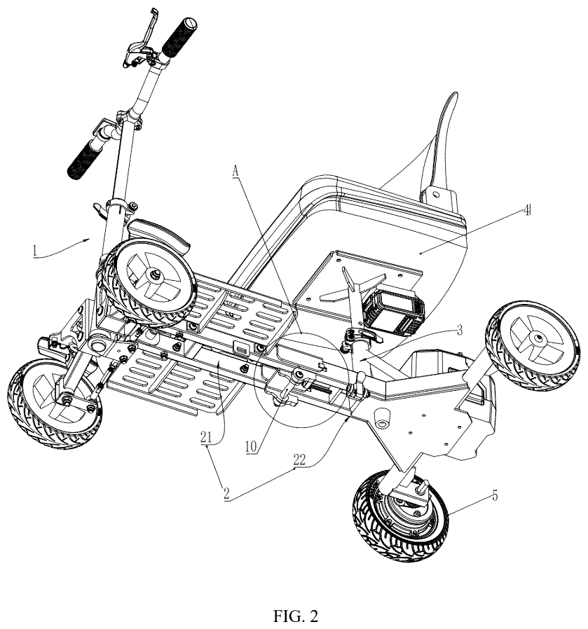

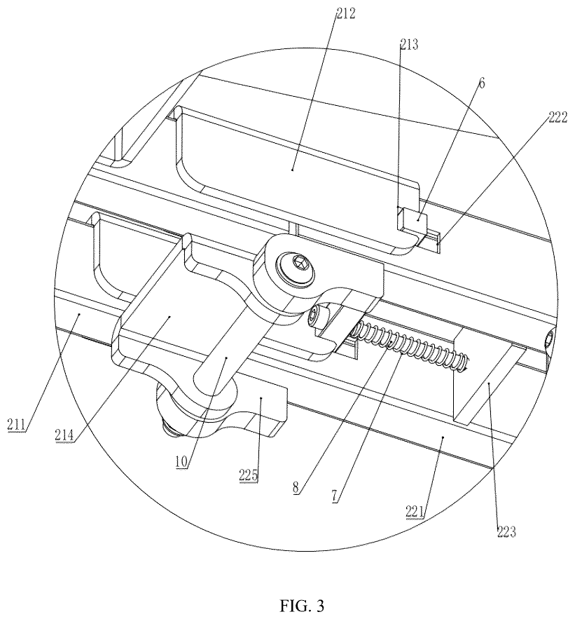

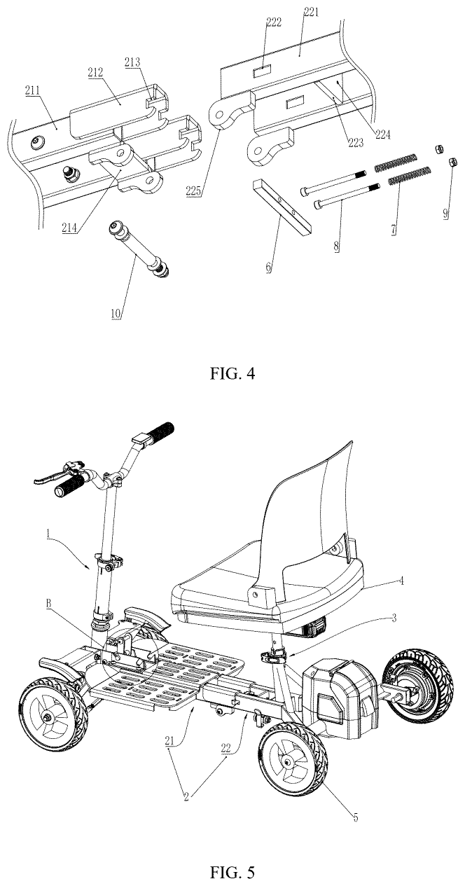

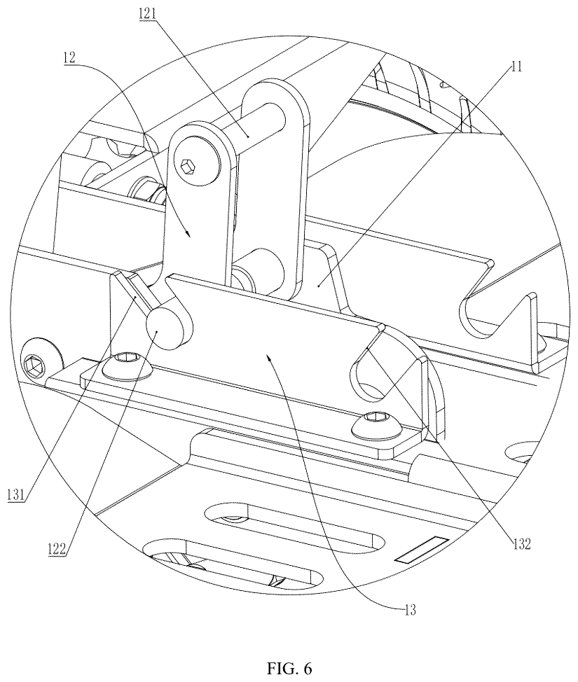

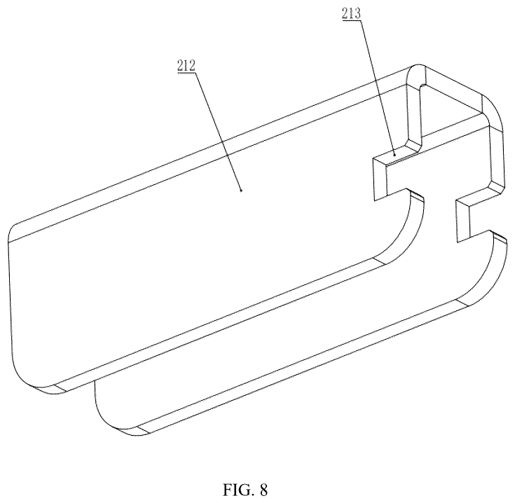

Referring to FIG. 1, FIG. 2, FIG. 3, FIG. 4, FIG. 5, and FIG. 8, a folding mobility scooter includes a handlebar assembly 1, a frame assembly 2, a support assembly 3, a seat 4, and wheels 5. The wheels 5 are rotatably connected to the frame assembly 2, the support assembly 3 is arranged on the frame assembly 2, the seat 4 is detachably connected to the support assembly 3, the handlebar assembly 1 is rotatably connected to the frame assembly 2, and an angle limiting device is arranged between the handlebar assembly 1 and the frame assembly 2; the frame assembly 2 includes a first frame 21 and a second frame 22, the first frame 21 includes first cross bars 211 and connecting seats 212, the connecting seats 212 are fixedly connected to the first cross bars 211, the connecting seats 212 are integrally in bent plate shapes, and the connecting seats 212 are provided with notches 213 along edges; the second frame 22 includes second cross bars 221, and the second cross bars 221 are provided with avoidance through holes 222 in a penetrating manner; a movable member 6 is movably connected in the avoidance through holes 222, and a sliding rod is connected to the movable member 6; a fixed plate 223 is fixedly connected to the second cross bars 221, the fixed plate 223 are provided with a via hole 224 for sliding connection with the sliding rod, and elastic members 7 are abutted against a position between the movable member 6 and the fixed plate 223; and after the first cross bars 211 and the second cross bars 221 are relatively unfolded, the second cross bars 221 are embedded in openings of the connecting seats 212 and abutted against interiors of the connecting seats 212, and the elastic members 7 drive the movable member 6 to be clamped into the notches 213.

Preferably, the support assembly 3 is connected to the second frame 22.

The handlebar assembly 1 is an existing common structure and will not be further described below, and the detachable connection of the seat 4 to the support assembly 3 is an existing common technology and will not be described in detail herein.

A user can restore a rotational connection state between the first frame 21 and the second frame 22 by pulling the movable member 6 to enable same to detach from the notches 213, making it very convenient to use; the second cross bars 221 are abutted against the interiors of the connecting seats 212 when the elastic members 7 drive the movable member 6 to be clamped into the notches 213; and the connecting seat 212 are abutted against the second cross bars 221 to limit limiting angles of the first cross bars 211 and the second cross bars 221, and to bear the bending force between the first cross bars 211 and the second cross bars 221, thus making force bearing points more numerous and the structure more stable.

Two second cross bars 221 are provided, the two second cross bars 221 are fixedly connected to two sides of the fixed plate 223, and the one movable member 6 is simultaneously connected into the avoidance through holes 222 on the two second cross bars 221.

The force on both sides of the movable member 6 is made more uniform, thus reducing the shaking caused by the movable member 6 during use and making the service condition more stable.

The movable member 6 is set in a strip shape, a cross-sectional shape of the movable member 6 is rectangular, a top surface of the movable member 6 fits with upper part side edges of the avoidance through holes 222, and a lower surface of the movable member 6 fits with lower part side edges of the avoidance through holes 222.

The upper and lower surfaces of the movable member 6 are allowed to fit with the upper and lower side edges of the avoidance through holes 222, making a sliding process of the movable member 6 more stable and easy to control.

The sliding rod includes bolts 8 and nuts 9, the bolts 8 are connected to the movable member 6, end portions of the bolts 8 pass through the via hole 224 and are connected to the nuts 9, and the elastic members 7 are springs sleeved outside the bolts 8.

The bolts 8, the nuts 9, and the elastic members 7 are all common parts on the market and thus do not need to be produced. The bolts 8 are connected to the movable member 6, pass through the springs and the via hole 224, and then are in screwed connection with the nuts 9, so that the installation of the sliding rod is completed. The installation steps are fewer, and the installation difficulty is low.

Two first cross bars 211 are provided, the two first cross bars 211 are both fixedly connected to a rotating seat 214, each of the two second cross bars 221 is provided with a rotating block 225, the rotating seat 214 is located between the two rotating blocks 225, and a rotating shaft 10 passes through both the rotating blocks 225 and the rotating seat 214.

The one rotating seat 214 is fixedly connected to the two first cross bars 211, so that the overall structure of the first frame 21 is more stable.

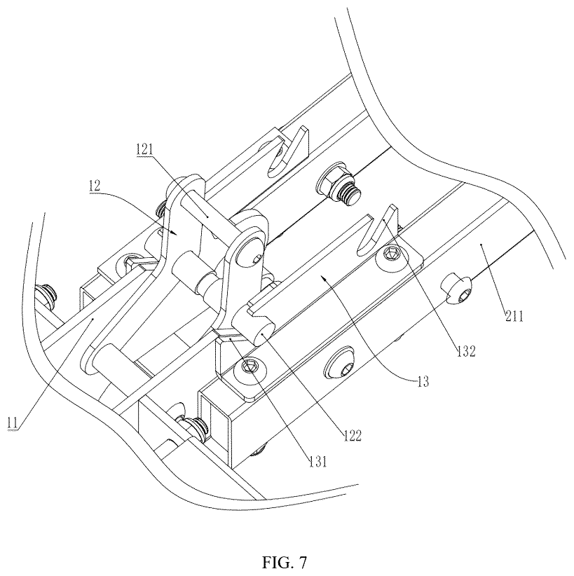

Referring to FIG. 5 to FIG. 7, the handlebar assembly 1 is and the first frame 21 are rotatably connected to each other; the angle limiting device includes a movable seat 11, a handle 12, and limiting plates 13; the limiting plates 13 are fixedly connected to the first frame 21, each of the limiting plates 13 is provided with a first limiting slot 131 and a second limiting slot 132, the handlebar assembly 1 is fixedly connected to the movable seat 11, the handle 12 is rotatably connected to the movable seat 11, and the handle 12 includes an operating rod 121 and a limiting rod 122; when the limiting rod 122 is clamped with the first limiting slots 131, the handlebar assembly 1 is in an unfolded and locked state relative to the first frame 21; and when the limiting rod 122 is clamped with the second limiting slots 132, the handlebar assembly 1 is in a folded and locked state relative to the first frame 21.

A user can control the handle 12 and allow the limiting rod 122 to be clamped into the first limiting slots 131 or the second limiting slots 132 to realize that the handlebar assembly 1 and the first frame 21 are locked in a relatively unfolded or folded state, so that the operation is very convenient.

Two limiting plates 13 are provided, the movable seat 11 is located between the two limiting plates 13, and two ends of the limiting rod 122 protrude from both sides of the handle 12.

The two ends of the limiting rod 122 cooperate with the first limiting slots 131 and the second limiting slots 132 on the two limiting plates 13, making the structure more stable when the angle limiting device is locked.

The first limiting slots 131 and the second limiting slots 132 are both extending in a strip shape, and angles formed between extension directions of the first limiting slots 131 and extension directions of the second limiting slots 132 range from 80 degrees to 100 degrees.

The first limiting slots 131 and the second limiting slots 132 are both extending in a strip shape, so that the connection between the first limiting slots 131 or the second limiting slots 132 and the limiting rod 122 is tighter, and detachment due to vibration is avoided during use. The angles formed between the extension directions of the first limiting slots 131 and the extension directions of the second limiting slots 132 are set reasonably, which ensures the effect of reducing the occupied space volume after folding.

Preferably, the angles formed between the extension directions of the first limiting slots 131 and the extension directions of the second limiting slots 132 are 90 degrees.

In the process of transforming the mobility scooter provided by the present disclosure from the integrally folded state to the integrally unfolded state, it is first necessary to drive the handle 12 to make the limiting rod 122 detach from the second limiting slots 132, and then to drive the handle 12 and insert the limiting rod 122 into the first limiting slots 131 to realize the angle locking of the handlebar assembly 1 and the first frame 21 after the handlebar assembly 1 and the first frame 21 are rotated and unfolded; after that, the first frame 21 and the second frame 22 are rotated and unfolded, and in this process, the movable member 6 is driven to avoid the connecting seats 212, until the movable member 6 is clamped into the notches 213, so that the locking between the first frame 21 and the second frame 22 can be completed; and the second cross bars 221 are embedded into the openings of the connecting seats 212.

The foregoing descriptions are merely exemplary embodiment of the present disclosure, and are not intended to limit the patent scope of the present disclosure. Under the inventive concept of the present disclosure, any equivalent structural changes made by using the contents of the Description and Drawings of the present disclosure, or direct/indirect applications in other related technical fields are included in the patent protection scope of the present disclosure.

What is claimed is:

1. A folding mobility scooter, comprising a handlebar assembly, a frame assembly, a support assembly, a seat, and wheels, the wheels being rotatably connected to the frame assembly, the support assembly being arranged on the frame assembly, and the seat being detachably connected to the support assembly, wherein the handlebar assembly is rotatably connected to the frame assembly, and an angle limiting device is arranged between the handlebar assembly and the frame assembly; the frame assembly comprises a first frame and a second frame, the first frame comprises first cross bars and connecting seats, the connecting seats are fixedly connected to the first cross bars, the connecting seats are integrally in bent plate shapes, and the connecting seats are provided with notches along edges; the second frame comprises second cross bars, and the second cross bars are provided with avoidance through holes in a penetrating manner; a movable member is movably connected in the avoidance through holes, and a sliding rod is connected to the movable member; a fixed plate is fixedly connected to the second cross bars, the fixed plate are provided with a via hole for sliding connection with the sliding rod, and elastic members are abutted against a position between the movable member and the fixed plate; and after the first cross bars and the second cross bars are relatively unfolded, the second cross bars are embedded in openings of the connecting seats and abutted against interiors of the connecting seats, and the elastic members drive the movable member to be clamped into the notches.

2. The folding mobility scooter according to claim 1, wherein two second cross bars are provided, the two second cross bars are fixedly connected to two sides of the fixed plate, and the one movable member is simultaneously connected into the avoidance through holes on the two second cross bars.

3. The folding mobility scooter according to claim 1, wherein the movable member is set in a strip shape, a cross-sectional shape of the movable member is rectangular, a top surface of the movable member fits with upper part side edges of the avoidance through holes, and a lower surface of the movable member fits with lower part side edges of the avoidance through holes.

4. The folding mobility scooter according to claim 2, wherein the movable member is set in a strip shape, a cross-sectional shape of the movable member is rectangular, a top surface of the movable member fits with upper part side edges of the avoidance through holes, and a lower surface of the movable member fits with lower part side edges of the avoidance through holes.

5. The folding mobility scooter according to claim 3, wherein the sliding rod comprises bolts and nuts, the bolts are connected to the movable member, end portions of the bolts pass through the via hole and are connected to the nuts, and the elastic members are springs sleeved outside the bolts.

6. The folding mobility scooter according to claim 4, wherein two first cross bars are provided, the two first cross bars are both fixedly connected to a rotating seat, each of the two second cross bars is provided with a rotating block, the rotating seat is located between the two rotating blocks, and a rotating shaft passes through both the rotating blocks and the rotating seat.

7. The folding mobility scooter according to claim 1, wherein the handlebar assembly and the first frame are rotatably connected to each other; the angle limiting device comprises a movable seat, a handle, and limiting plates; the limiting plates are fixedly connected to the first frame, each of the limiting plates is provided with a first limiting slot and a second limiting slot, the handlebar assembly is fixedly connected to the movable seat, the handle is rotatably connected to the movable seat, and the handle comprises an operating rod and a limiting rod; when the limiting rod is clamped with the first limiting slots, the handlebar assembly is in an unfolded and locked state relative to the first frame; and when the limiting rod is clamped with the second limiting slots, the handlebar assembly is in a folded and locked state relative to the first frame.

8. The folding mobility scooter according to claim 2, wherein the handlebar assembly and the first frame are rotatably connected to each other; the angle limiting device comprises a movable seat, a handle, and limiting plates; the limiting plates are fixedly connected to the first frame, each of the limiting plates is provided with a first limiting slot and a second limiting slot, the handlebar assembly is fixedly connected to the movable seat, the handle is rotatably connected to the movable seat, and the handle comprises an operating rod and a limiting rod; when the limiting rod is clamped with the first limiting slots, the handlebar assembly is in an unfolded and locked state relative to the first frame; and when the limiting rod is clamped with the second limiting slots, the handlebar assembly is in a folded and locked state relative to the first frame.

9. The folding mobility scooter according to claim 4, wherein the handlebar assembly and the first frame are rotatably connected to each other; the angle limiting device comprises a movable seat, a handle, and limiting plates; the limiting plates are fixedly connected to the first frame, each of the limiting plates is provided with a first limiting slot and a second limiting slot, the handlebar assembly is fixedly connected to the movable seat, the handle is rotatably connected to the movable seat, and the handle comprises an operating rod and a limiting rod; when the limiting rod is clamped with the first limiting slots, the handlebar assembly is in an unfolded and locked state relative to the first frame; and when the limiting rod is clamped with the second limiting slots, the handlebar assembly is in a folded and locked state relative to the first frame.

10. The folding mobility scooter according to claim 5, wherein the handlebar assembly and the first frame are rotatably connected to each other; the angle limiting device comprises a movable seat, a handle, and limiting plates; the limiting plates are fixedly connected to the first frame, each of the limiting plates is provided with a first limiting slot and a second limiting slot, the handlebar assembly is fixedly connected to the movable seat, the handle is rotatably connected to the movable seat, and the handle comprises an operating rod and a limiting rod; when the limiting rod is clamped with the first limiting slots, the handlebar assembly is in an unfolded and locked state relative to the first frame; and when the limiting rod is clamped with the second limiting slots, the handlebar assembly is in a folded and locked state relative to the first frame.

11. The folding mobility scooter according to claim 6, wherein two limiting plates are provided, the movable seat is located between the two limiting plates, and two ends of the limiting rod protrude from both sides of the handle.

12. The folding mobility scooter according to claim 7, wherein the first limiting slots and the second limiting slots are both extending in a strip shape, and angles formed between extension directions of the first limiting slots and extension directions of the second limiting slots range from 80 degrees to 100 degrees.
